(19) United States
(12) Patent Application Publication
(10) Pub. No.: US 2010/0043846 A1
(43) Pub. Date: Feb. 25, 2010

(54) Enviro-Kleen Machine

(76) Inventor: Keith McCollum, Forney, TX (US)

Correspondence Address: WILSON DANIEL SWAYZE, JR., 3804 CLEARWATER CT., PLANO, TX, 75025, US

(21) Appl. No.: 12/131,100

(22) Filed: Jun. 1, 2008

(51) Int. Cl. B08B 3/00

(52) U.S. Cl. 134/110

(57) ABSTRACT

A portable in line cleaning system for cleaning engine components may include a portable housing including a storage tank for storage of a solution to clean the engine components a pump to pump the solution from the storage tank to the engine components, a first filter to filter the solution before the solution is transported to the engine components and a second filter to filter the solution has to the solution has been transported to the engine components. The portable housing may include a first wall connection device to connect an internal connection tube to an external connection tube, and the external connection tube may be connected to an entrance port to the engine components. The internal connection tube may be connected to the first filter, and the portable housing may include a second wall connection device to connect a internal return connection tube to a external return connection tube. The external return connection tube may be connected to an exit port of the engine components, and the internal return connection tube may be connected to a second filter device.

### FIELD OF THE INVENTION

The present invention relates to an apparatus for cleaning fuel and combustion systems, more particularly, fuel lines, combustion chambers, fuel injectors and injection pumps.

### BACKGROUND OF THE INVENTION

Prior art methods of cleaning electronic fuel injectors include generally of two methods. The first utilizes immersing the injectors or injector tips in an ultrasonic bath of cleaning fluid. This method, however, only cleans the injector nozzle tip and the filter basket. A second method such as the RAM FIC-109 system, utilizes a forced flow and/or forced back flow of cleaning fluid through the injector. Whilst each system has its advantages, they also have their disadvantages in that they do not fully clean all of the pathways of the injector and hence the injector will not operate at optimum efficiency or may need to be replaced.

A third method is that described in U.S. Pat. No. 4,082,565. This device uses a gravity feed of cleaning fluid through the injectors in the normal direction as they are being periodically pulsed with tips being immersed in an ultrasonic bath. This method suffers from disadvantages in that it does not allow impurity particles trapped in the filter basket to be readily removed during cleaning and also requires a separate reservoir of cleaning fluid and connections to the inlets of the injectors to flow fluid therethrough.

U.S. Pat. No. 4,774,015 discloses a carburetor cleaner containing ingredients which are not listed as hazardous by the Director of the California Department of Industrial Relations. Said cleaner comprises water, sodium meta silicate, trisodium phosphate, the tetrasodium salt of ethylene diamine tetraacetic acid, sodium or potassium hydroxide, tall oil fatty acids, a synthetic detergent, and butyl carbitol.

U.S. Pat. No. 6,820,627 discloses a fuel injector cleaner injection device for use with an automobile having an engine having a fuel injection system, a fuel supply, and a fuel line extending between the fuel supply and fuel injection system, the device having a main housing defining an interior volume, and a reservoir. The main housing has a fuel in port which is connected to the fuel line toward to the fuel supply, a fuel out port which is connected to the fuel line toward the engine, and a cleaner in port in communication with the reservoir through an adjustment valve. During use of the automobile, fuel flows from the fuel supply through the fuel in port through the interior volume to the fuel out port into the engine. Fuel injector cleaner from the reservoir is introduced into the fuel flow through the cleaner in port, under the control of the adjustment value.

U.S. Pat. No. 6,820,627 discloses an apparatus for cleaning an electronic fuel injector having an inlet and an outlet wherein the fuel injector is supported in an ultrasonic bath of cleaning fluid such that at least the outlet tip of the fuel injector is immersed in the fluid while the bath is resonated with ultrasonic energy. The fuel injector is pulsed by an electrical signal, the combination of the ultrasonic resonance and pulsing action causing the fluid to flow through the fuel injector from the outlet tip to the inlet.

### SUMMARY

A portable in line cleaning system for cleaning engine components may include a portable housing including a storage tank for storage of a solution to clean the engine components a pump to pump the solution from the storage tank to the engine components, a first filter to filter the solution before the solution is transported to the engine components and a second filter to filter the solution has to the solution has been transported to the engine components.

The portable housing may include a first wall connection device to connect an internal connection tube to an external connection tube, and the external connection tube may be connected to an entrance port to the engine components.

The internal connection tube may be connected to the first filter, and the portable housing may include a second wall connection device to connect a internal return connection tube to a external return connection tube.

The external return connection tube may be connected to an exit port of the engine components, and the internal return connection tube may be connected to a second filter device.

The solution may include hydro-treated neutral oil, and the solution may include Butanol.

The solution may include Cyclohexanone, and the solution may include a Lubrizol proprietary additive package.

The solution may include an oil-soluble blue dye, and the solution may include Crysylol.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates the diesel dialysis system of the present invention.

### DETAILED DESCRIPTION

The diesel dialysis system works in a similar way as the human dialysis machine works. The diesel dialysis system of the present invention operates without removing any of the engine components which includes the entire fuel and combustion systems including the fuel lines, the combustion chambers, the fuel injectors, and any injection pump may be cleaned in a few simple steps. The diesel dialysis system is an in line cleaning system that connects to the engine through specific adapters which adapt to the specific manufacturer and model being cleaned. The diesel dialysis system reduces, removes and eliminates fuel deposits that may build up in the fuel injectors, injector pumps and combustion chambers. A significant advantage of the diesel dialysis system is a significant reduction in exhaust emissions and an increase in fuel economy.

The process of the diesel dialysis system is first, the diesel dialysis system is connected to the fuel system inlet of the vehicle and the fuel system return line with using adapters which are specific to the engine being cleaned.

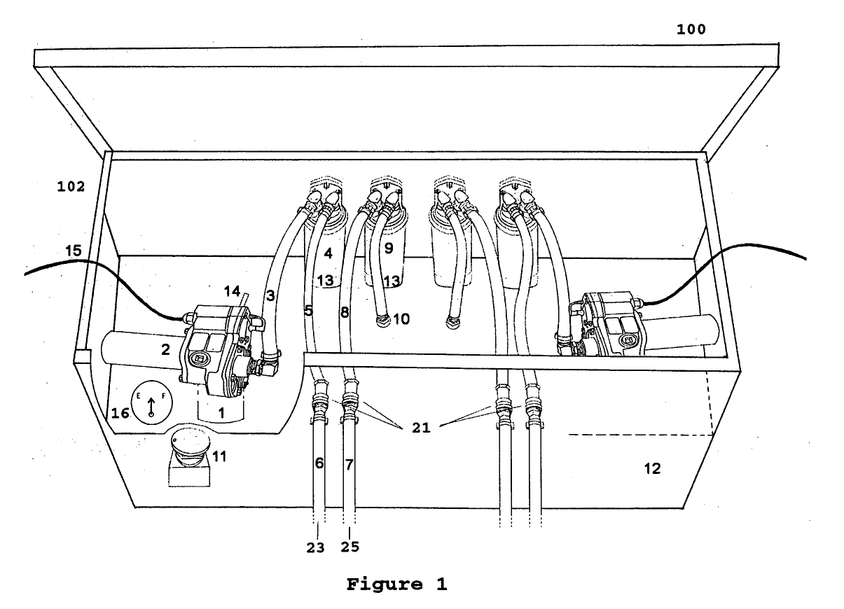

FIG. 1 illustrates a portable diesel dialysis system 100 in accordance with the teachings of the present invention which includes a portable housing 102 for housing the diesel dialysis system. FIG. 1 illustrates a pump intake tube 1 to transfer the solution from the storage tank 12 which may be a 50 gallon storage tank or other size storage tank to the pump device 2 to pump the solution from the storage tank 12 to the engine (not shown). The pump device 2 pumps the solution to the connection tube 3 which is connected between the pump device 2 and the fuel separator filter device 4. The fuel separator filter device 4 filters the solution in order to remove particles from the solution. The internal engine connection tube 5 connects the fuel separator filter device 4 to a first wall connection device 21 which is connected to an external engine connection tube 6 which is connected to the engine at an entrance port 23 to the engine components.

The pump device 2 pumps the solution through the pump intake tube 1 from the storage tank 12 and pumps the solution to the connection tube 3. The solution flows through the fuel separator filter device 4 to be filtered and then the solution flows out of the fuel separator filter device 4 through the internal engine connection tube 5 to the external engine connection tube 6 which connects with the engine so that the solution can flow through the engine.

The solution flows through the engine and cleans the engine typically while the engine is running. The cleaning process results in the solution becoming contaminated with contaminants in the fuel system and engine components. The contaminated solution should now be returned to the storage tank 12.

The solution flows from the engine at an exit port 25 of the engine components to the external return connection tube 7 to connect to a second wall connection device 21 which connects to the internal return connection tube 8 which connects to a second fuel separator filter device 9 which removes the contaminates from the contaminated solution so that it can be returned to the storage tank 12. A second connection tube 10 connects to the second fuel separator filter 9 and connects to the storage tank 12 to return the filtered solution to the storage tank 12.

FIG. 1 additionally illustrates a second system in the portable housing 100 so that a second vehicle can be simultaneously serviced.

The portable system 100 of the present invention will eventually lose solution and this lost solution will need to be replaced. FIG. 1 illustrates a fuel reservoir device 11 to allow new solution to be added to the storage tank 12. FIG. 1 additionally illustrates a fuel sight bowl 16 to provide an indication of the amount of solution within the storage tank 12. FIG. 1 illustrates a on/off switch 14 for the pump device 2 and a power cord 15 to power the pump device 2. The solution may include hydro-neutral oil CAS #72623-85-9,2-Butanol CAS #78-92-2, Crysylol CAS #108-94-1, Lubrizol Proprietary Additive Package, and Oil-Soluble Blue Dye.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A portable in line cleaning system for cleaning engine components, comprising:
a portable housing including a storage tank for storage of a solution to clean the engine components;
a pump to pump the solution from the storage tank to the engine components;
a first filter to filter the solution before the solution is transported to the engine components;
a second filter to filter the solution has to the solution has been transported to the engine components.

2. A portable in line cleaning system for cleaning engine components as in claim 1, wherein the portable housing includes a first wall connection device to connect an internal connection tube to an external connection tube.

3. A portable in line cleaning system for cleaning engine components as in claim 2, wherein the external connection tube is connected to an entrance port to the engine components.

4. A portable in line cleaning system for cleaning engine components as in claim 2, wherein the internal connection tube is connected to the first filter.

5. A portable in line cleaning system for cleaning engine components as in claim 1, wherein the portable housing includes a second wall connection device to connect a internal return connection tube to a external return connection tube.

6. A portable in line cleaning system for cleaning engine components as in claim 5, wherein the external return connection tube is connected to an exit port of the engine components.

7. A portable in line cleaning system for cleaning engine components as in claim 5, wherein the internal return connection tube is connected to a second filter device.

8. A portable in line cleaning system for cleaning engine components as in claim 1, wherein the solution includes hydro-treated neutral oil.

9. A portable in line cleaning system for cleaning engine components as in claim 1, wherein the solution includes Butanol.

10. A portable in line cleaning system for cleaning engine components as in claim 1, wherein the solution includes Crysylol.

11. A portable in line cleaning system for cleaning engine components as in claim 1, wherein the solution includes Cyclohexanone.

12. A portable in line cleaning system for cleaning engine components as in claim 1, wherein the solution includes a Lubrizol proprietary additive package.

13. A portable in line cleaning system for cleaning engine components as in claim 1, wherein the solution includes an oil-soluble blue dye.
